(19) United States
(12) Patent Application Publication
(10) Pub. No.: US 2014/0361172 A1
(43) Pub. Date: Dec. 11, 2014

(54) DETECTION OF H2S IN NATURAL GAS AND HYDROCARBON STREAMS USING A DUAL-PATH NEAR-IR SPECTROSCOPY SYSTEM

(71) Applicant: JP3 Measurement, LLC, Austin, TX (US)

(72) Inventors: Joseph Paul Little, III, Austin, TX (US); William Tsakopulos, Austin, TX (US); Matt Thomas, Austin, TX (US)

(21) Appl. No.: 14/301,736

(22) Filed: Jun. 11, 2014

Related U.S. Application Data
(60) Provisional application No. 61/833,531, filed on Jun. 11, 2013.

(51) Int. Cl. G01N 21/35; G01N 21/27

(52) U.S. Cl. CPC G01N 21/35; G01N 21/3577; G01N 21/3504; G01N 21/27; G01N 2201/0612; G01N 2201/105
USPC 250/339.06

(57) ABSTRACT

Methods and systems for real time, in situ detection of a contaminant in a fluid, and particularly the determination of hydrogen sulfide concentration in a natural gas or other hydrocarbon stream, are provided. The system may include a scanning source with wavelength scanning range of 1560-1610 nm and wavelength resolution of 0.01 nm or better. The light from the scanning source is split to two portions: reference path to reference detector with no fluid in the transmission, and sample path to sample detector with fluid in the transmission. The major noise from the light source and transmitting optics is cancelled out by applying log ratio calculation to the two detector signals. The spectroscopic optical data, however obtained, must then be combined into an analytical processing module containing models that analyze the contaminant quantitative data.

### CROSS-REFERENCE TO RELATED APPLICATIONS

This application claims priority based upon prior U.S. Provisional Patent Application Ser. No. 61/833,531 filed Jun. 11, 2013, in the name of Joseph Paul Little III, Bill Tsakopulos, and Matt Thomas, entitled “DETECTION OF H2S IN NATURAL GAS AND HYDROCARBON STREAMS USING A DUAL-PATH NEAR-IR SPECTROSCOPY SYSTEM,” the entire disclosure of which is incorporated herein by reference.

### FIELD OF THE INVENTION

This invention relates to the real time, in situ measurement of hydrogen sulfide (H₂S) in natural gas and other hydrocarbon streams using near infrared (NIR) absorption spectroscopy.

### BACKGROUND OF THE INVENTION

Natural gas is a mixture primarily of methane (CH₄) and other hydrocarbons plus carbon dioxide (CO₂), nitrogen (N₂), hydrogen sulfide (H₂S) and water (H₂O). The hydrogen sulfide component is an extremely toxic and irritating gas, causing eye irritation, dizziness, coughing, and headaches at low concentrations and unconsciousness or death at higher concentration if released into the local environment. In addition to its adverse human health effects, the presence of hydrogen sulfide in natural gas can cause sulfide stress cracking and hydrogen-induced cracking to the lines through which the gas is transmitted. Consequently, most natural gas processing facilities treat natural gas to neutralize the hydrogen sulfide, so it is important to accurately measure the amount of hydrogen sulfide present so that appropriate amounts of chemical neutralizer may be added. For these and other reasons, it is important to be able to accurately detect the amount of hydrogen sulfide in the system during transmission.

Gas chromatographs and lead acetate analyzers are conventional online hydrogen sulfide measurement instruments. They both are extractive type analyzers in that the sample is extracted from the process and transported to the analyzer for analysis. Complex sampling systems are required to maintain the integrity of the sample. The analysis cycle time is typically several minutes, which is not convenient to evaluate short-term process variations. Routine maintenance is a must, as the failure of an injection valve on a gas chromatograph or failure to replace the tape when it is consumed and/or replenishing the bubbler solution on a lead acetate analyzer can cause false readings. Near infrared (NIR) spectrographic analysis has proven to be a better method for determining hydrogen sulfide and other components in natural gas. The measurements are made at the operating temperature and pressure of the fluid infrastructure without the need to extract and alter a representative sample, thereby minimizing the possibility of sample contamination and the risk of analyzing material that is not truly representative of the fluid in the process line. In addition, the analysis time is usually a few seconds, which allows the analyzer to capture any short-term changes in the sample.

However, determining the amount of hydrogen sulfide in situ in a natural gas stream under pressure is extremely difficult. Hydrogen sulfide has a weak NIR spectral signature and needs to be measured in very trace amounts (ppm levels) in gas and liquid phase hydrocarbon streams. This requires incredibly high resolution and very low noise (i.e., high signal to noise ratio). For this reason, a multipass cell (e.g. a Herriot cell or a ring-down cavity) is typically used to increase the light path length for enhanced absorption signal. Unfortunately, these multipass cells cannot survive the in-situ measurement condition because of difficulties in keeping optical alignment and the internal mirrors clean. Therefore, the measurement has to be performed with sample extracted, filtered, and transported to the measurement cell, which reduces the attractiveness of using optical measurement method.

Additionally, many of the other species present in a hydrocarbon stream, most notably methane and carbon dioxide, interfere with the hydrogen sulfide signature. The interference is even worse under the high-pressure process condition due to the collisional broadening of absorption features. For a tunable diode laser spectrometer with high wavelength scanning resolution but narrow wavelength scanning range, single hydrogen sulfide absorption line is typically used for analysis. The extractive method has to be used and the measurement is performed under atmospheric or low vacuum pressure to reduce the spectroscopic interference. Sometimes, a scrubbing system is applied to remove the hydrogen sulfide content in the sample to capture the interfering absorption feature for future hydrogen sulfide analysis (often referred to as background subtraction). This complicates the entire system design, and if there are errors in the captured background, all future test results will be affected.

There is a need, therefore, for a method and system for using NIR spectroscopy in situ, under operating pressure, and in real time to reliably detect the presence of trace quantities of hydrogen sulfide in the natural gas and other hydrocarbon fluids. This system must be able to detect multiple absorbance bands of the hydrogen sulfide molecule over the high wavelength resolution scan with great signal to noise ratio and be able to distinguish these from the other peaks in the region.

### SUMMARY OF THE INVENTION

This invention provides a trace level hydrogen sulfide detection method and system which achieves high signal to noise ratio, low interference from other components in hydrocarbons streams, and real time in situ NIR spectroscopic measurement.

In one embodiment, a high resolution widely tunable scanning light source scans from approximately 1560 nm up to 1610 nm to cover the entire hydrogen sulfide NIR absorption band instead of a single absorption line. The wavelength scanning resolution is 0.01 nm or better to capture detailed absorption features of hydrogen sulfide and other undesirable components. The light beam is transmitted through an optical fiber to a beam splitter. One portion of the beam is directed to a reference detector and has no sample (i.e. no analyte) associated with it. The rest of the beam is sent through the sample path and react with the analyte before reaching a sample detector. The absorption spectrum can be calculated by applying a log ratio algorithm to the two detector signals based on Beer-Lambert law. The majority of the spectral noise comes from the light source and transmitting optics, which is caught by both detectors and cancelled out after absorption spectrum calculation. This, therefore, improves the signal to noise ratio significantly to achieve trace level hydrogen sulfide detection.

Post-processing methods can be utilized to standardize the results, such as calculating the first derivative, normalizing for pressure, and possibly using other processing techniques, such as extended multiplicative scatter correction. In addition, post-processing methods can be used to calculate or otherwise determine the amount of hydrogen sulfide in the natural gas or other hydrocarbon stream based on the dual-path spectroscopic data.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a dual-path optical system operable to measure hydrogen sulfide in natural gas or other hydrocarbon streams;

FIG. 2 shows absorption spectra simulated from HITRAN2012 database to illustrate the spectral interference of hydrocarbons and carbon dioxide to hydrogen sulfide analysis; and

FIG. 3 shows an example of a collected spectrum using one embodiment of the present invention plotting absorption against wavelengths between 1560 nm and 1610 nm.

### DESCRIPTION OF THE PREFERRED EMBODIMENTS

The present invention is directed to improved methods and systems for, among other things, detecting trace level hydrogen sulfide contaminant in a natural gas or other hydrocarbon stream. The configuration and use of the presently preferred embodiments are discussed in detail below. It should be appreciated, however, that the present invention provides many applicable inventive concepts that can be embodied in a wide variety of contexts other than detection of hydrogen sulfide contaminant in a hydrocarbon stream. Accordingly, the specific embodiments discussed are merely illustrative of specific ways to make and use the invention, and do not limit the scope of the invention.

U.S. Pat. No. 8,686,364 describes a method and system for determining energy content and detecting contaminants in a fluid stream. The system consists of a spectrometer, an optical system and a processing module. The present invention also describes an optical system design for detecting contaminants, specifically hydrogen sulfide in natural gas and other hydrocarbon streams. The same NIR light source with high resolution and wide wavelength scanning range is applied, as well as the similar processing module. However, certain improvements of the present invention provide an optical system design for the sample measurement that significantly reduces the overall spectral noise. Because hydrogen sulfide has very weak NIR absorption features, its signal is lost or impaired by the noise in the spectrographic system. The major contribution of spectral noise is from the light source and transmitting optics (especially optical fiber). One category of noise is the short-term light power fluctuation within one wavelength scan caused by the instability of light source temperature control and optical fringe effect. Another category of noise is the long-term drift caused by light source aging and ambient temperature variation. In addition, the absorption signal of hydrogen sulfide is convoluted with other absorption signals from hydrocarbons and carbon dioxide, making a precise determination of hydrogen sulfide seemingly inaccurate or impossible. However, through use of the embodiments of the present invention, the signal to noise ratio is greatly improved and it is possible to determine the quantity of hydrogen sulfide in the fluid.

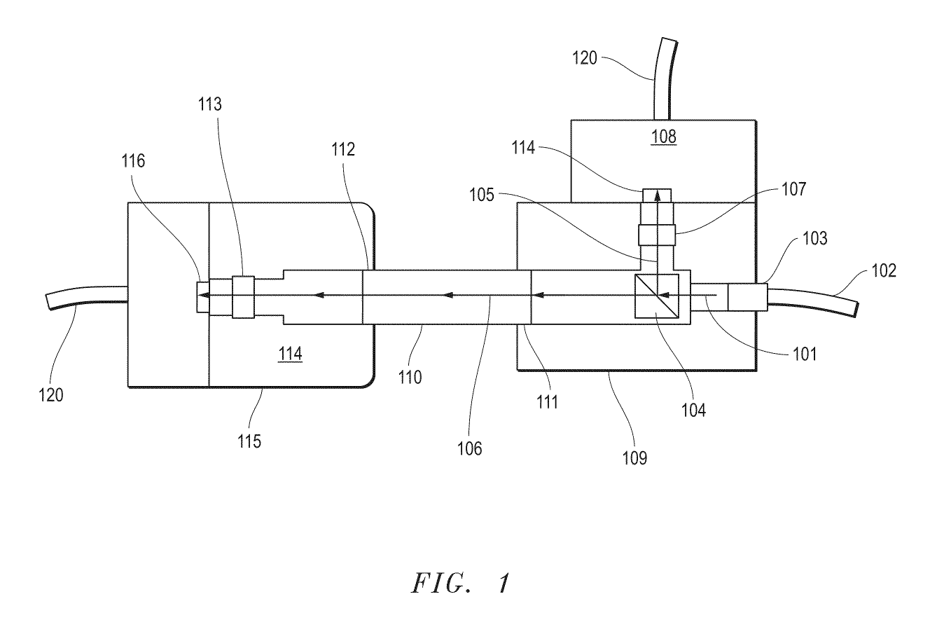

A representative embodiment of an optical measurement system is shown in FIG. 1. The NIR light signal 101 from a spectrometer through a NIR source fiber 102 is collimated to a parallel beam by a collimating lens 103. The incoming light 101 is preferably a wide tuning signal with wavelength range of 1560 nm to 1610 nm and wavelength resolution of 0.01 nm or better. The parallel beam is then split into a reference beam 105 and a sample beam 106 by a NIR beam splitter 104. The reference beam 105 is directed to a reference detector 108 through a focusing lens 107. There is no measurement sample in the reference path, so that the signal of reference detector over wavelength is proportional to the incoming light intensity.

The sample beam 106 passes through a sample cell, which is isolated between a first cell window 111 and a second cell window 112. The sample beam is then directed to a sample detector 114 through a focusing lens 113. The split ratio of the beam splitter can be any value, but in some embodiments it is preferable to have more light power on the sample path to improve transmission through the possibly dirty sample. Both reference detector 108 and sample detector 114 may, for example, be an Indium Gallium Arsenide (InGaAs) photodiode, and their photo signals (photocurrent) are electronically amplified locally before sending to the spectrometer for digitization and post processing. The digitization may also be performed immediately after the amplification circuitry, to achieve digital communication between spectrometer and optical measurement system. The two detectors must be calibrated against one another so that any variation in signal from the source fiber will be caught and have the same ratioed response between the two detectors.

The processing module first calculates the absorption spectrum using the following equation: α=log(I_{ref}/Iₛₐₘₚₗₑ), where I_{ref} is the reference detector signal and Iₛₐₘₚₗₑ is the sample detector signal. It is obvious that the power variation from the light source and the optical noise generated by the transmitting fiber are canceled out by the log ratio algorithm, and a very precise absorbance value at any given x-axis value (wavelength value) is derived. This innovative method and system tremendously reduces the overall spectral noise for the calculated absorption spectrum. The processing module will then process the spectrographic data and other measured fluid properties such as temperature and pressure, using various chemometric models and computational techniques to determine the hydrogen sulfide concentration of the gas. The results will then be stored for a later transmission and analysis, sent directly to a data gathering location, or both.

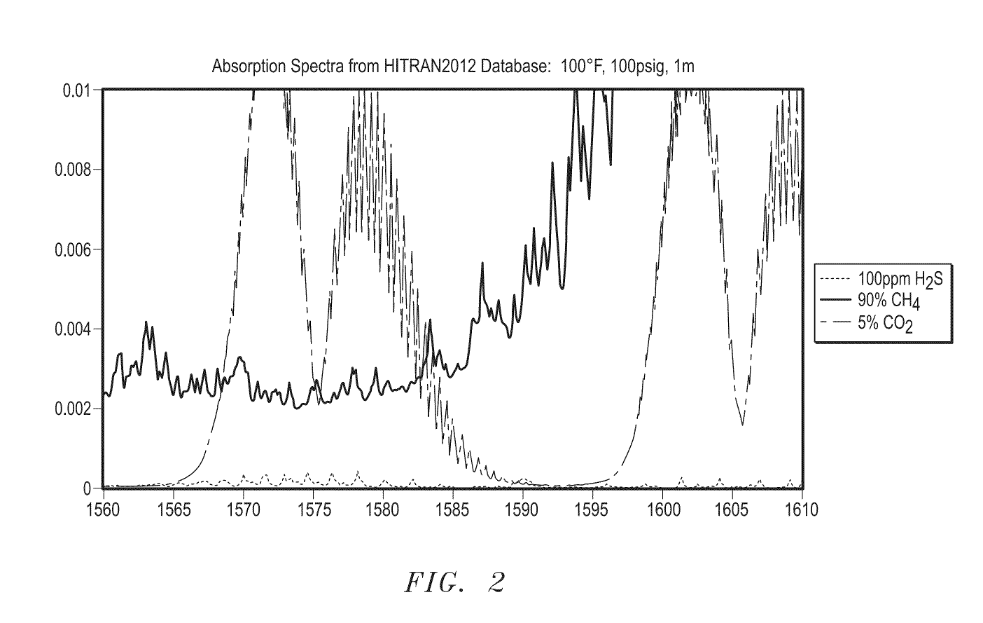

FIG. 2 provides HITRAN2012 simulated spectra of 100 parts per million hydrogen sulfide, 90% methane and 5% carbon dioxide to illustrate the great spectral interference for detection of hydrogen sulfide concentration. The spectra are calculated under the sample conditions of 100° F. temperature, 100 psig pressure and 1 meter optical path length. It will be apparent to those skilled in the art that the hydrogen sulfide spectra is much weaker than the methane and carbondioxide signals and that no clean hydrogen sulfide absorption region is available for detection.

Some tunable diode lasers (TDLs) known in the art have a very high wavelength resolution, but very narrow wavelength range. The prior art takes advantage of this by only focusing on a single peak of hydrogen sulfide absorption; however, there are two problems with this approach in practice. The first is that other species of gas present in the gas stream will have overlapping absorption spectra with the hydrogen sulfide as illustrated in FIG. 2. If only the narrow spectral range is considered then the interference feature cannot be distinguished from the hydrogen sulfide signal. The second is that if pressure is increased, the hydrogen sulfide absorption peak gets broadened and the ability to achieve accurate measurement using just a very narrow, non-scanned beam such as that of a TDL is compromised.

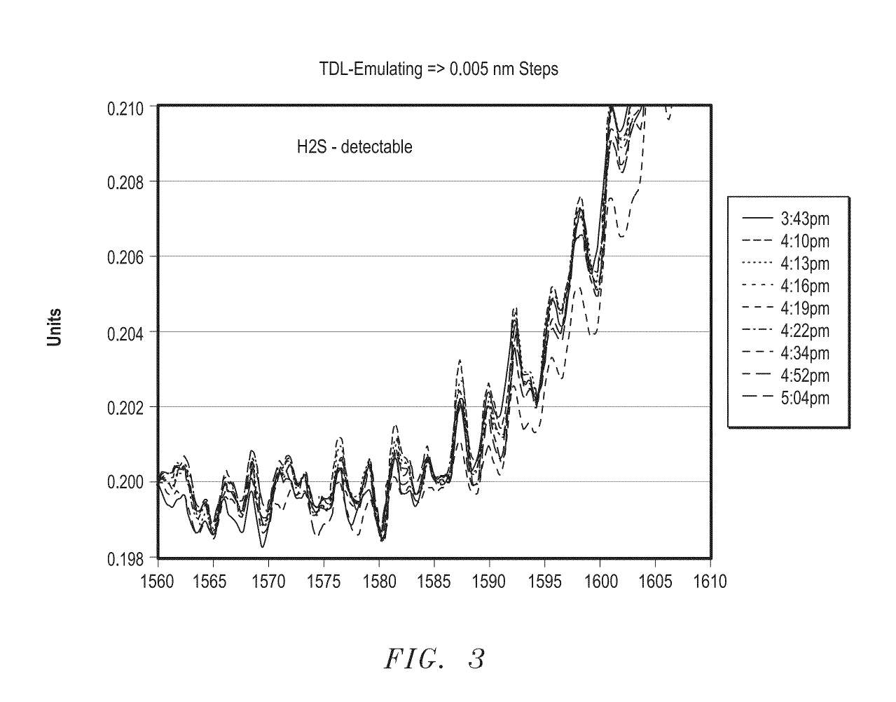

Embodiments of the present invention employ a very high resolution source that scans the responsive range of the hydrogen sulfide signal in the NIR and thus overcomes both of these obstacles. FIG. 3 shows an example of a collected spectrum using one embodiment of the present invention plotting absorption against wavelengths between 1560 nm and 1610 nm.

U.S. Pat. No. 8,686,364 which was issued to the same inventors as the present invention, describes a method of determining the level of contaminant is a fluid stream. In that case, the absorption spectrum calculated from the log ratio of two detector signals is preprocessed and manipulated using certain models and algorithms such as taking the first order derivative, EMSC processing, Savitzky-Golay smoothing, box car smoothing, and/or pressure & temperature adjustment. A multivariate regression analysis is then performed on the preprocessed data, followed by the regression vector establishment. All of this processed data is then provided to the proprietary concentration derivation models, yielding the desired output values for hydrogen sulfide concentration.

Using the present invention, it is possible to separate the hydrocarbon spectral signatures from the hydrogen sulfide or other contaminant spectral signatures and, therefore, to eliminate the effect of the hydrocarbon signal overlapping or interfering with the contaminant (e.g., hydrogen sulfide) signal. Once the interference from the hydrocarbons on the contaminant signal is eliminated, it is possible to detect the contaminant at low concentrations (e.g., hydrogen sulfide at concentrations as low as 1 ppm).

In some embodiments, the process of converting the raw spectroscopic data via the processing module may then involve dividing the first derivative spectrum by the pressure (in psi) for normalization. One or more calibration models may then be applied to the normalized first derivative spectrum to hydrogen sulfide concentration. It is then possible to employ multivariate empirical modeling methods to develop various calibration models. The models can use one or more of the following elements: (i) principal components analysis (PCA) and partial least squares (PLS) regression to uncover optimal modeling strategies and to detect potential outliers in the calibration data set; (ii) if any sample or spectral variables are detected in the calibration data, exclude them from being used to build the models; (iii) use of partial least squares (PLS) regression to construct predictive calibration models from the calibration data generating a series of regression coefficients which, when multiplied with the absorbance values of an unknown gas sample's spectrum, yield the property of interest; (iv) use of genetic algorithms (GA) to select subsets of the spectral response variables to use in the predictive models to make the PLS models more robust with respect to known interfering effects in the spectra; and/or (v) use of PCA to generate an “outlier model” which can be run on-line to assess whether a field-collected spectrum is abnormal with respect to the spectra that were used to develop the models.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for determining the amount of contaminants present in a fluid known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method of determining a quantity of a trace level contaminant in a fluid comprising:
splitting an incoming light from a scanning source into a reference beam and a sample beam;
transmitting the reference beam to a first detector without passing through a fluid sample to be tested;
transmitting the sample beam through the fluid sample to be tested to a second detector;
acquiring absorption information from the first detector and the second detector;
determining quantity of a trace level contaminant in the fluid sample to be tested using spectrographic analysis from the absorption information.

2. The method of claim 1 wherein the scanning source is a near infrared tunable laser.

3. The method of claim 1, wherein the scanning source scans between about 1560 nm and about 1610 nm.

4. The method of claim 1, wherein the wavelength resolution of the scanning source is 0.01 nm or higher.

5. The method of claim 1, wherein at least one of the first detector and the second detector is an Indium Gallium Arsenide photodiode.

6. The method of claim 1 where the splitting is caused by an optical beam splitter or a fiber coupler.

7. The method of claim 1, wherein the trace level contaminant is hydrogen sulfide.

8. The method of claim 1, wherein the fluid is natural gas.

9. The method of claim 1, wherein the fluid is liquefied natural gas.

10. The method of claim 1, wherein the fluid is a hydrocarbon gas stream.

11. A system for determining the quantity of a trace level contaminant in a fluid comprising:
a scanning source;
a first optical path that does not pass through a fluid sample to be tested;
a second optical path that passes through the fluid sample to be tested;
a device for splitting a light from the scanning source into a reference beam and a sample beam, wherein the reference beam is transmitted through the first optical path to a first detector and the sample bean is transmitted through the second optical path to a second detector; and
a processor that processes absorption information from the first detector and the second detector and calculates the quantity of a trace level contaminant in the fluid sample to be tested.

12. The system of claim 11 wherein the scanning source is a near infrared tunable laser.

13. The system of claim 11, wherein the scanning source scans between about 1560 nm and about 1610 nm.

14. The system of claim 11, wherein the wavelength resolution of the scanning source is 0.01 nm or higher.

15. The system of claim 11, wherein at least one of the first detector and the second detector is an Indium Gallium Arsenide photodiode.

16. The system of claim 1 where the device for splitting a light from the scanning source is an optical beam splitter or a fiber coupler.

17. The system of claim 11, wherein said trace level contaminant is hydrogen sulfide.

18. The system of claim 11, wherein said fluid is natural gas.

19. The system of claim 1, wherein said fluid is liquefied natural gas.

20. The system of claim 11, wherein said fluid is a hydrocarbon gas.
